(19) United States
(12) Patent Application Publication
(10) Pub. No.: US 2016/0140953 A1
(43) Pub. Date: May 19, 2016

(54) SPEECH SYNTHESIS APPARATUS AND CONTROL METHOD THEREOF

(71) Applicant: SAMSUNG ELECTRONICS CO., LTD., Suwon-si (KR)

(72) Inventor: Jae-sung KWON, Suwon-si (KR)

(73) Assignee: SAMSUNG ELECTRONICS CO., LTD., Suwon-si (KR)

(21) Appl. No.: 14/928,259

(22) Filed: Oct. 30, 2015

(30) Foreign Application Priority Data
Nov. 17, 2014 (KR) 10-2014-0159995

(51) Int. Cl. G10L 13/10; G10L 13/07; G10L 13/047

(52) U.S. Cl. CPC G10L 13/10; G10L 13/047; G10L 13/07

(57) ABSTRACT

A speech synthesis apparatus and method is provided. The speech synthesis apparatus includes a speech parameter database configured to store a plurality of parameters respectively corresponding to speech synthesis units constituting a speech file, an input unit configured to receive a text including a plurality of speech synthesis units, and a processor configured to select a plurality of candidate unit parameters respectively corresponding to a plurality of speech synthesis units constituting the input text, from the speech parameter database, to generate a parameter unit sequence of a partial or entire portion of the text according to probability of concatenation between consecutively concatenated candidate unit parameters, and to perform a synthesis operation based on hidden Markov model (HMM) using the parameter unit sequence to generate an acoustic signal corresponding to the text.

### CROSS-REFERENCE TO RELATED APPLICATIONS

This application claims priority from Korean Patent Application No. 10-2014-0159995, filed on Nov. 17, 2014 in the Korean Intellectual Property Office, the disclosure of which is incorporated herein by reference in its entirety.

### BACKGROUND

1. Field

Apparatuses and methods consistent with various embodiments of the present disclosure relate to a speech synthesis apparatus and a control method thereof, and more particularly, to a speech synthesis apparatus and a control method thereof, for converting an input text into voice.

2. Description of the Related Art

Recently, along with development of speech synthesis technology, speech synthesis technology has been widely used in various speech guidance fields, educational fields, and so on. Speech synthesis is technology for generating a similar sound to sound that the human speaks and is also frequently known as a text to speech (TTS) system. The speech synthesis technology transmits information to a user as a speech signal instead of a text or a picture and thus is very useful when a user cannot see a screen of an operating machine as in the case in which a user is driving or is blind. Recently, home smart devices in a smart home, such as a smart television (TV) or a smart refrigerator, or personal portable devices such as a smart phone, an electronic book reader or a vehicle navigation device, have been actively developed and have become widely popular. Accordingly, there is a rapidly increasing need for speech synthesis technology and for an apparatus for speech output.

In this regard, there is a need for a method for enhancing sound quality of synthesized speech, in particular, a method for generating synthesized speech with excellent naturalness.

### SUMMARY

Exemplary embodiments of the present disclosure overcome the above disadvantages and other disadvantages not described above. Also, embodiments of the present disclosure are not required to overcome the disadvantages described above, and an exemplary embodiment of the present disclosure may not overcome any of the problems described above.

Various embodiments of the present disclosure provide a speech synthesis apparatus and a control method thereof, for compensating various prosodic modifications in speech generated using a hidden Markov model (HMM)-based speech synthesis scheme to generate natural synthesized speech.

According to an aspect of various embodiments of the present disclosure, a speech synthesis apparatus for converting an input text into speech includes a speech parameter database configured to store a plurality of parameters respectively corresponding to speech synthesis units constituting a speech file, an input unit configured to receive a text including a plurality of speech synthesis units, and a processor configured to select a plurality of candidate unit parameters respectively corresponding to a plurality of speech synthesis units constituting the input text, from the speech parameter database, to generate a parameter unit sequence of a partial or entire portion of the text according to probability of concatenation between consecutively concatenated candidate unit parameters, and to perform a synthesis operation based on hidden Markov model (HMM) using the parameter unit sequence to generate an acoustic signal corresponding to the text.

The processor may sequentially combine candidate unit parameters, searches for a concatenation path of the candidate unit parameters according to the probability of concatenation between the candidate unit parameters, and combine candidate unit parameters corresponding to the concatenation path to generate the parameter unit sequence of the partial or entire portion of the text.

The speech synthesis apparatus may further include a storage configured to store an excitation signal model, wherein the processor may apply the excitation signal model to the text to generate a HMM speech parameter corresponding to the text and apply the parameter unit sequence to the generated HMM speech parameter to generate the acoustic signal.

The storage may further store a spectrum model required to perform the synthesis operation, and the processor may apply the excitation signal model and the spectrum model to the text to generate a HMM speech parameter corresponding to the text.

According to another aspect of various embodiments of the present disclosure, a control method of a speech synthesis apparatus, for converting an input text to speech includes receiving a text including a plurality of speech synthesis units, selecting a plurality of candidate unit parameters respectively corresponding to a plurality of speech synthesis units constituting the input text, from a speech parameter database for storing a plurality of parameters corresponding to speech synthesis units constituting a speech file, generating a parameter unit sequence of a partial or entire portion of the text according to probability of concatenation between consecutively concatenated candidate unit parameters, and performing a synthesis operation based on hidden Markov model (HMM) using the parameter unit sequence to generate an acoustic signal corresponding to the text.

The generating of the parameter unit sequence may include sequentially combining a plurality of candidate unit parameters respectively corresponding to the plurality of speech synthesis units and searching for a concatenation path of the candidate unit parameters according to the probability of concatenation between the candidate unit parameters, and combining candidate unit parameters corresponding to the concatenation path to generate the parameter unit sequence of the partial or entire portion of the text.

The generating of the acoustic signal may include applying an excitation signal model to the text to generate a HMM speech parameter corresponding to the text, and applying the parameter unit sequence to the generated HMM speech parameter to generate the acoustic signal.

The searching of the concatenation path of the candidate unit parameters may use a searching method via a viterbi algorithm.

The generating of the HMM speech parameter may include further applying a spectrum model required to perform the synthesis operation to the text to generate a HMM speech parameter corresponding to the text.

According to the aforementioned various embodiments of the present disclosure, synthesized speech with enhanced naturalness may be generated compared with synthesized speech via a conventional HMM speech synthesis method, thereby enhancing user convenience.

Additional and/or other aspects and advantages of various embodiments of the present disclosure will be set forth in part in the description which follows and, in part, will be obvious from the description, or may be trained by practice of the invention.

### BRIEF DESCRIPTION OF THE DRAWINGS

The above and/or other aspects of various embodiments of the present disclosure will be more apparent by describing certain exemplary embodiments of the present disclosure with reference to the accompanying drawings, in which:

FIG. 1 is a diagram for explanation of an example in which a speech synthesis apparatus is embodied and used as a smart phone;

FIG. 2 is a schematic block diagram illustrating a configuration of a speech synthesis apparatus according to an exemplary embodiment of the present disclosure;

FIG. 3 is a block diagram illustrating a configuration of a speech synthesis apparatus in detail according to another exemplary embodiment of the present disclosure;

FIG. 4 is a diagram for explanation of a configuration of a speech synthesis apparatus according to an exemplary embodiment of the present disclosure;

FIG. 5 is a diagram for explanation of a configuration of a speech synthesis apparatus according to another exemplary embodiment of the present disclosure;

FIGS. 6 and 7 are diagrams for explanation of a method for generating a parameter unit sequence according to an exemplary embodiment of the present disclosure; and

FIG. 8 is a flowchart for explanation of a speech synthesis method according to an exemplary embodiment of the present disclosure.

### DETAILED DESCRIPTION

Certain exemplary embodiments of the present disclosure will now be described in greater detail with reference to the accompanying drawings.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

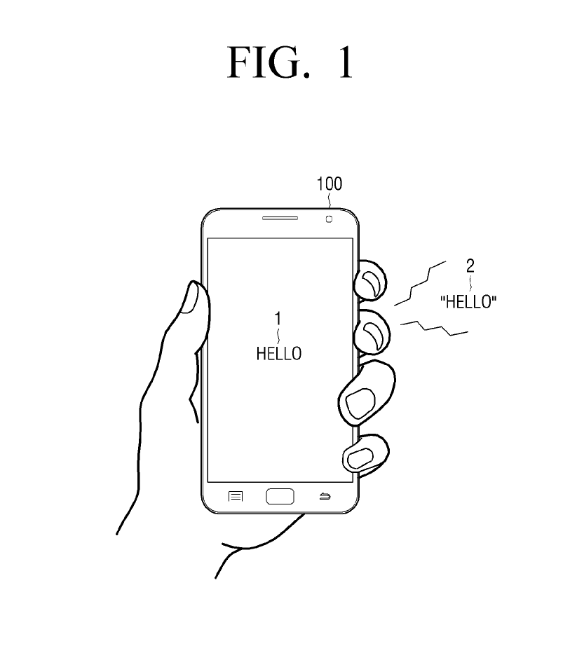

FIG. 1 is a diagram for explanation of an example in which a speech synthesis apparatus is embodied and used as a smart phone 100.

As illustrated in FIG. 1, in response to a text 1 of “Hello” being input to the smart phone 100, the smart phone 100 may convert the text 1 into speech 2 through a machine and output the speech 2 through a speaker of the smart phone 100. A text to be converted into speed may be input directly by a user through a smart phone or may be input by downloading content such as an electronic book to the smart phone. The smart phone may automatically convert the input text into speech and output the speech or may output speech by pushing a speech conversion button by the user. To this end, there is a need for an embedded speech synthesizing device to be used in a smart phone or the like.

With regard to an embedded system, a hidden Markov model (HMM)-based speech synthesis scheme has been used as a scheme for speech synthesis. The HMM-based speech synthesis scheme is a parameter-based speech synthesis scheme and is proposed so as to generate synthesized speech having various properties.

In the HMM-based speech synthesis scheme using a theory used in speech coding, parameters corresponding to the spectrum, pitch, and duration of speech may be extracted and trained using the HMM. In a synthesis operation, synthesized speed may be generated using a parameter estimated from the training result and a vocoder scheme of speech coding. Since the HMM-based speech synthesis scheme needs only a parameter extracted from a speech database, the HMM-based speech synthesis scheme requires low capacity and thus is useful in an embedded system environment such as a mobile system or a CE device but is disadvantageous in that naturalness of synthesized speech is degraded. Accordingly, various embodiments of the present disclosure are provided to overcome this disadvantage in the HMM-based speech synthesis scheme.

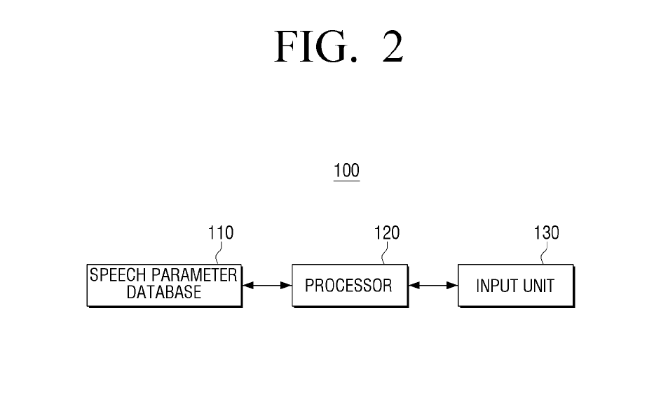

FIG. 2 is a schematic block diagram illustrating a configuration of a speech synthesis apparatus 100 according to an exemplary embodiment of the present disclosure.

Referring to FIG. 2, the speech synthesis apparatus 100 according to an exemplary embodiment of the present disclosure may include a speech parameter database 110, a processor 120, and an input unit 130.

The speech parameter database 110 may be a component for storing parameters about various speech synthesis units and various prosodic modifications of the synthesis unit. Prosody adjustment may be minimized through parameters of the various prosodic modifications to generate natural synthesized speech.

Here, the speech synthesis unit may be a basic unit of speech synthesis and refers to a phoneme, a semisyllable, a syllable, a di-phone, a tri-phone, and so on, and may be embodied in a small amount if possible in terms of efficiency from a memory point of view. In general, as the synthesis unit, a semisyllable, a di-phone, a tri-phone, and so on, which are capable of maintaining transition between adjacent speeches while minimizing distortion of spectrum during concatenation between speeches and having an appropriate number of data items, may be used. The di-phone refers to a unit for concatenation between phonemes obtained by cutting a middle portion of a phoneme, and since the di-phone includes a phoneme transition portion, clarity may be easily obtained. The tri-phone refers to a unit indicating a phoneme and right and left environments of the phoneme and applies an articulation phenomenon to easily process a concatenation portion. Hereinafter, for convenience of description, although the case in which a speech synthesis unit is embodied as a di-phone is described, embodiments of the present disclosure are not limited thereto. In addition, hereinafter, for convenience of description, although the case in which a speech synthesis apparatus of Korean is embodied is described, embodiments of the present disclosure are not limited thereto, and needless to say, a speech synthesis apparatus for synthesizing speech of other country languages such as English may also be embodied. In this case, the speech parameter database 110 may establish a set of various speech synthesis units of various country languages and parameters of various prosodic modifications of the synthesis unit.

The parameters of the various prosodic modifications may be parameters corresponding to a speech synthesis unit constituting an actual speech file and may include labeling information, prosody information, and so on. The labeling information refers to information obtained by recording start and end points, that is, a boundary of each phoneme constituting speech in a speech file. For example, when ‘father’ is phonated, the labeling information is a parameter for determining start and end points of each phoneme ‘f’, ‘a’, ‘t’, ‘h’, ‘e’ or ‘r’ in a speech signal. The speech labeling result is a process for subdividing given speech according to a phoneme string, and the subdivided speech pieces are used as basic units of linkage of speech synthesis and thus may largely affect sound quality of synthesized speech.

The prosody information may include prosody boundary strength information, and information of the length, intensity, and pitch as three requisites of prosody. The prosody boundary strength information is information about phonemes between which a boundary of an accentual phrase (AP) is positioned. The pitch information may refer to information of intonation, a pitch of which is changed according to time, and pitch variation may be generally referred to as intonation. Intonation may be defined as a speech melody made by a pitch of voice as generally known. The length information may refer to information about duration time of a phoneme and may be obtained using the phoneme labeling information. The intensity information may refer to information obtained by recording representative intensity information of phonemes within a boundary of the phonemes.

A process for selecting various sentences may be preferentially performed for actual speech recording to be stored, and the selected sentence needs to include all synthesis units (di-phones) and needs to include various prosodic modifications. As the number of recorded sentences to be used to establish a speech parameter database is reduced, it is more efficient in terms of capacity. To this end, a unique di-phone and a repetition rate thereof may be examined with respect to a text corpus, and a sentence may be selected using a repetition rate file.

A plurality of parameters stored by the speech parameter database 110 may be extracted from a speech database of a speech synthesis unit based on a hidden Markov model (HMM).

The processor 120 controls an overall operation of the speech synthesis apparatus 100.

In particular, the processor 120 may select a plurality of candidate unit parameters that respectively correspond to a plurality of speech synthesis units constituting an input text, from the speech parameter database 110, may generate a parameter unit sequence of a partial or entire portion of the text according to probability of concatenation between consecutively concatenated candidate unit parameters, and may perform a synthesis operation based on a hidden Markov model (HMM) using a parameter unit sequence to generate an acoustic signal corresponding to the text.

When an input text is ‘this’, ‘this’ may be represented by ‘(##+t)-(h+i)-(i+s)-(s+##)’ in terms of a di-phone unit. That is, the word ‘this’ may be generated by concatenating 4 di-phones. Here, a plurality of speech synthesis units constituting an input text may refer to each di-phone.

In this case, the processor 120 may select a plurality of candidate unit parameters that respectively correspond to speech synthesis units constituting a text input from the speech parameter database 110. The speech parameter database 110 may establish a set of candidate unit parameters of respective country languages. The candidate unit parameters may refer to prosody information about a phoneme including each corresponding di-phone. For example, a parameter including (s+t) as one unit of the input text may be, for example, ‘street’, ‘star’, ‘test’, and so on, and prosody information about (s+t) may be changed according to each respective parameter. Accordingly, the processor 120 may search various parameters of respective di-phones, i.e., a plurality of candidate unit parameters and may retrieve optimum candidate unit parameters. This process may be generally performed by calculating target cost and concatenation cost. The target cost may refer to a value of a distance between feature vectors such as a pitch, energy, intensity, and spectrum of candidate parameters and a speech synthesis unit to be retrieved in the speech parameter database 110, and may be used to estimate a degree at which the speech synthesis unit constituting a text and the candidate unit parameter are similar. As the target cost becomes lowest, the accuracy of synthesized speech may be enhanced. The concatenation cost may refer to a prosody difference generated when two candidate unit parameters are adhered and may be used to estimate suitability of concatenation between consecutively concatenated candidate unit parameters. The concatenation cost may be calculated using a distance between the aforementioned feature vectors. As a prosody difference between the candidate unit parameters is reduced, sound quality of synthesized speech may be enhanced.

When candidate unit parameters are determined for the respective di-phones, an optimum concatenation path needs to be retrieved and may be formed by calculating concatenation probability between the candidate unit parameters and retrieving candidate unit parameters with highest concatenation probability. This is the same as a process for retrieving candidate unit parameters with lowest cumulative cost of the sum of the target cost and the concatenation cost. As the retrieving method, viterbi search may be used.

The processor 120 may combine candidate unit parameters corresponding to the respective optimum concatenation paths to generate a parameter unit sequence corresponding to a partial or entire portion of the text. That is, the processor 120 may perform a synthesis operation based on hidden Markov model using a parameter unit sequence to generate an acoustic signal corresponding to a text. That is, this process applies the parameter unit sequence to a HMM speech parameter generated by a model trained by HMM to generate a natural speech signal with compensated prosody information. Here, the model trained by HMM may include only an excitation signal model and may further include a spectrum model. In this case, the processor 120 may apply the model trained by HMM to the text to generate a HMM speech parameter corresponding to the text.

The input unit 130 is a component for receiving a text to be converted into speech. The text to be converted into speech may be input directly by a user through a speech synthesis apparatus or may be input by downloading content such as an electronic book by a smart phone. Accordingly, the input unit 130 may include a button, a touchpad, a touchscreen, or the like, for receiving a text directly from the user. In addition, the input unit 130 may include a communication unit for downloading content such as an electronic book. The communication unit may include various communication chips such as a WiFi chip, a Bluetooth chip, a NFC chip, and a wireless communication chip so as to communicate with an external device or an external server using various types of communication methods.

The speech synthesis apparatus 100 according to an embodiment of the present disclosure is useful in an embedded system such as a portable terminal device such as a smart phone but is not limited thereto, and needless to say, the speech synthesis apparatus 100 may be embodied as various electronic apparatuses such as a television (TV), a computer, a laptop PC, a desk top PC, and a tablet PC.

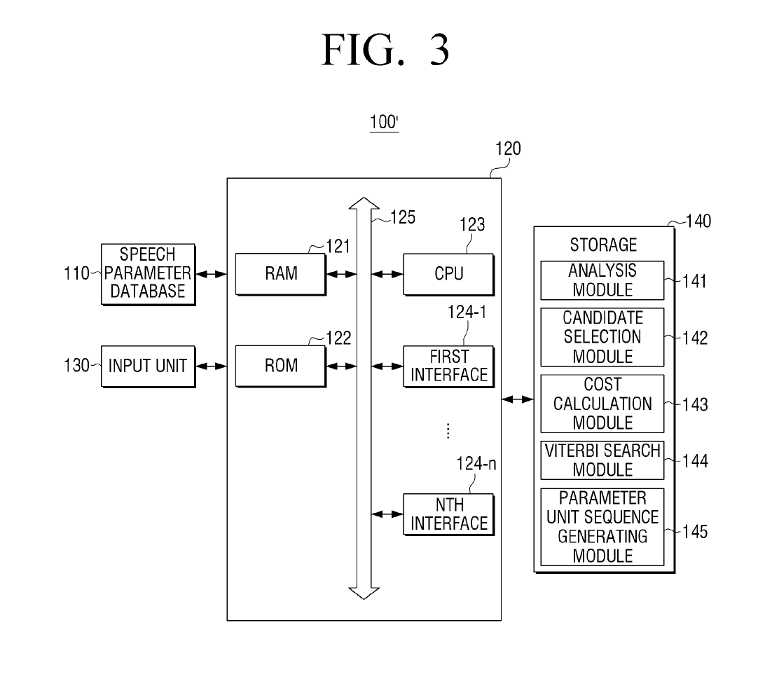

FIG. 3 is a block diagram illustrating a configuration of a speech synthesis apparatus 100 in detail according to another exemplary embodiment of the present disclosure.

Referring to FIG. 3, the speech synthesis apparatus 100 according to another exemplary embodiment of the present disclosure may include the speech parameter database 110, the processor 120, the input unit 130, and a storage 140. Hereinafter, a repeated detailed description in the detailed description of FIG. 2 will be omitted.

The storage 140 may include an analysis module 141, a candidate selection module 142, a cost calculation module 143, a viterbi search module 144, and a parameter unit sequence generating module 145.

The analysis module 141 is a module for analyzing an input text. An input sentence may contain an acronym, an abbreviation, a number, a time, a special letter, and so on in addition to a general letter, and the input sentence is converted into a general text sentence before synthesized into speech. This is referred to as text normalization. Then the analysis module 141 may write a letter the way it sounds in normal orthography in order to generate natural synthesized speech. Then, the analysis module 141 may analyze grammar of a text sentence via a syntactic parser to discriminate between word classes of words and analyze information for prosody control according to interrogative sentence, declarative sentence, and so on. The analyzed information may be used to determine a candidate unit parameter.

The candidate selection module 142 may be a module for selecting a plurality of candidate unit parameters that respectively correspond to speech synthesis units constituting a text. The candidate selection module 142 may search for various modifications corresponding to the respective speech synthesis units of the input text, that is, a plurality of candidate unit parameters based on the speech parameter database 110 and may determine sound unit parameters appropriate for speech synthesis of the speech synthesis units as candidate unit parameters. The number of candidate unit parameters of the respective speech synthesis units may be changed according to whether matching is achieved or not.

The cost calculation module 143 is a module for calculation of probability of concatenation between the candidate unit parameters. To this end, a cost function obtained by sum of the target cost and the concatenation cost may be used. The target cost may be obtained by calculating a matching degree with an input label with respect to candidate unit parameters, may be calculated using prosody information such as a pitch, intensity, and a length as a feature vector, and may be measured in consideration of various feature vectors such as context feature, a distance with a speech parameter, and probability. The concatenation cost may be used to measure a distance and continuity between consecutive candidate unit parameters and may be measured in consideration of a pitch, intensity, spectral distortion, a distance with a speech parameter, or the like as a feature vector. A weighted sum obtained by calculating a distance between the feature vector and applying a weight may be used as a cost function. A total cost function equation may be used as the following equation.

$$\text{?} = \text{?} \text{?} \text{?} \text{?} + \text{?} \text{?} \text{?} ( \text{?} ) + \text{?} + \text{?} \\ \text{?} \text{indicates text missing or illegible when filed} \qquad [ Equation 1 ]$$

Here, Cⱼ^{t}(uᵢ,uᵢ) and Cⱼ^{c}(uᵢ₋₁,uᵢ) are target sub cost and concatenation sub cost, respectively. i is a unit index and j is a concatenation sub cost index. n is the number of total candidate unit parameters and p and q are the number of sub costs. In addition, S is a silent syllable, u is a candidate unit parameter, and w is a weight.

The viterbi search module 144 is a module for searching for an optimum concatenation path of each candidate unit parameter according to the calculated concatenation probability. An optimum concatenation path with excellent dynamics and stability of concatenation between consecutive candidate unit parameters among candidate unit parameters of each label may be obtained. Viterbi search may be a process for searching for a candidate unit parameter with minimum cumulative cost of the sum of target cost and concatenation cost and may be performed using a cost calculating result value calculated by a cost calculating module.

The parameter unit sequence generating module 145 is a module for combining respective candidate unit parameters corresponding to optimum concatenation paths to generate a parameter unit sequence corresponding to a length of an input text. The generated parameter unit sequence may be input to a HMM parameter generating module and applied to a HMM speech parameter obtained by synthesizing the input text based on HMM.

The processor 120 may control an overall operation of a speech recognition apparatus 100′ using various modules stored in the storage 140.

As illustrated in FIG. 3, the processor 120 may include a RAM 121, a ROM 122, a CPU 123, first to n^{th} interfaces 124-1 to 124-n, and a bus 125. In this case, the RAM 121, the ROM 122, the CPU 123, the first to n^{th} interfaces 124-1 to 124-n, and so on may be concatenated with each other through the bus 125.

The ROM 122 may store a command set for system booting. The CPU 123 may copy various program programs stored in the storage 140 to the RAM 121 and execute the application program copied to the RAM 121 to perform various operations.

The CPU 123 may control an overall operation of the speech synthesis apparatus 100′ using various modules stored in the storage 140.

The CPU 123 may access the storage 140 and perform booting using an operating system (O/S) stored in the storage 140. In addition, the CPU 123 may perform various operations using various programs, contents, data, and so on, which are stored in the storage 140.

In particular, the CPU 123 may perform a speech synthesis operation based on HMM. That is, the CPU 123 may analyze an input text to generate a context-dependent phoneme label and select HMM corresponding to each label using a pre-stored excitation signal model. Then the CPU 123 may generate an excitation parameter through a parameter generating algorithm based on output distribution of the selected HMM and may configure a synthesis filter to generate a synthesis speech signal.

The first to n^{th} interfaces 124-1 to 124-n may be concatenated with the aforementioned various components. One of the interfaces may be a network interface concatenated with an external device through a network.

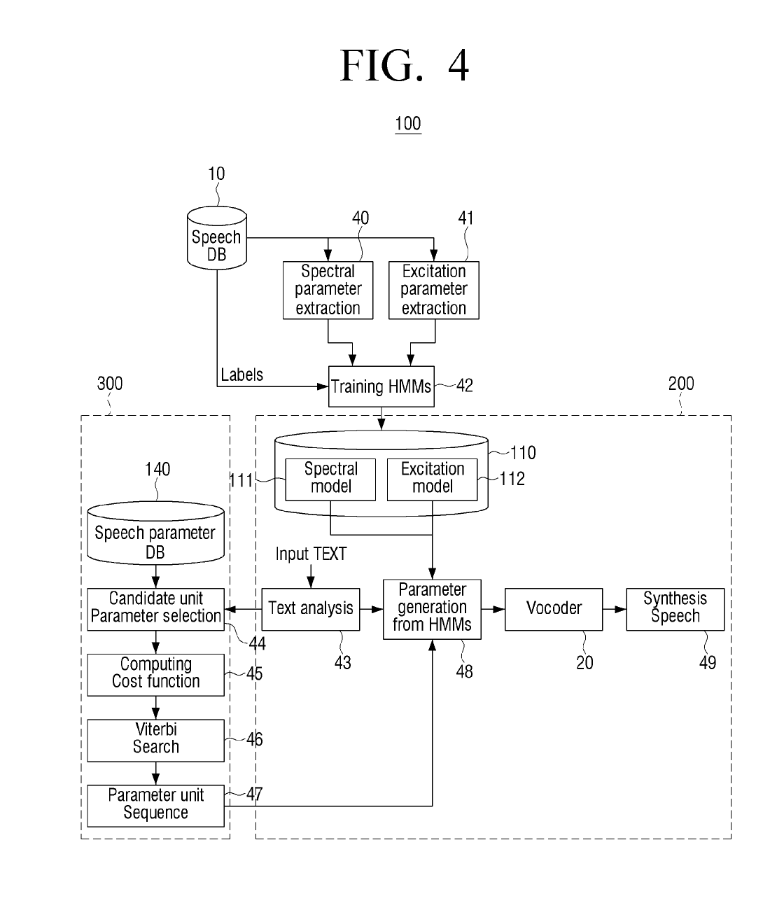

FIG. 4 is a diagram for explanation of a configuration of the speech synthesis apparatus 100 according to an exemplary embodiment of the present disclosure.

Referring to FIG. 4, the speech synthesis apparatus 100 may largely include a HMM-based speech synthesis unit 200 and a parameter sequence generator 300. Hereinafter, a repeated detailed description in the detailed description of FIGS. 2 and 3 will be omitted.

A HMM-based speech synthesis method may be largely classified into a training part and a synthesis part. Here, the HMM-based speech synthesis unit 200 according to an exemplary embodiment of the present disclosure may include a synthesis part for synthesizing speech using an excitation signal model generated in the training part. Accordingly, the speech synthesis apparatus 100 according to an exemplary embodiment of the present disclosure may perform only the training part using a pre-trained model.

In the training part, a speech database (speech DB) 10 may be analyzed to generate a parameter required in the synthesis part as a statistical model. A spectrum parameter and an excitation parameter may be extracted from the speech database 10 (spectral parameter extraction 40 and excitation parameter extraction 41), and may be trained using labeling information of the speech database 10 (training HMMs 42). A spectral model 111 and an excitation signal model 112 as a last speech model may be generated via a decision tree clustering process.

In the synthesis part, an input text may be analyzed (text analysis 43) to generate a label data containing context information, and a HMM state parameter may be extracted from a speech model using the label data (parameter generation from HMMs 48). The HMM state parameter may be mean/variance values of static and delta features. A parameter extracted from the speech model may be used to generate a parameter for each frame via a parameter generating algorithm using a maximum likelihood estimation (MLE) scheme and to generate a last synthesized speech through a vocoder.

The parameter sequence generator 300 is a component for deriving a parameter unit sequence of a time domain from an actual speech parameter database in order to enhance naturalness and dynamic of synthesized speech generated by the HMM-based speech synthesis unit 200.

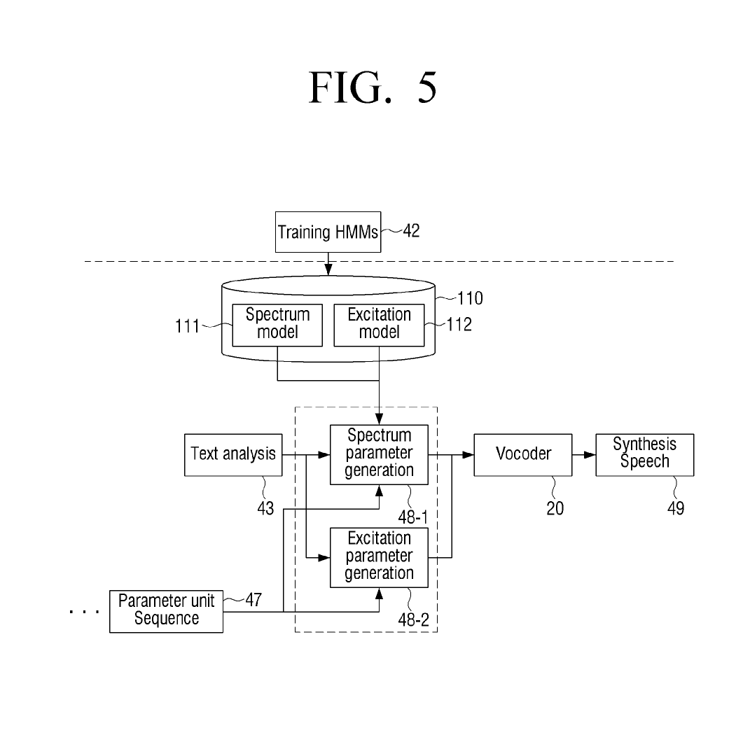

A speech parameter database (speech parameter DB) 140 may store a plurality of speech parameters and label segmentation information items, and parameters of various prosodic modifications of a synthesis unit, which are extracted from the speech database 10. Then the input text may be text-analyzed (text analysis 43) and then a candidate unit parameter may be selected (candidate unit parameter selection 44). Then a cost function may be calculated to calculate target cost and concatenation cost (computing cost function 45), and an optimum concatenation path between consecutive candidate unit parameters may be derived via viterbi search (viterbi search 46). Accordingly, a parameter unit sequence corresponding to a length of the input text may be generated (parameter unit sequence 47), and the generated parameter unit sequence may be input to a HMM parameter generating module (parameter generation from HMMs) 48 of the HMM-based speech synthesis unit 200. Here, the HMM parameter generating module 48 may be an excitation signal parameter generating module and may include an excitation signal parameter generating module and a spectrum parameter generating module. In particular, a configuration of the HMM parameter generating module 48 will be described with reference to FIG. 5.

FIG. 5 is a diagram for explanation of a configuration of a speech synthesis apparatus according to another exemplary embodiment of the present disclosure. FIG. 5 illustrates an example in which the HMM parameter generating module 48 includes both a spectrum parameter generating module (spectrum parameter generation) 48-1 and an excitation signal parameter generating module (excitation parameter generation) 48-2.

A parameter unit sequence generated by the parameter sequence generator 300 may be combined with the spectrum parameter generating module 48-1 and the excitation signal parameter generating module 48-2 of the HMM parameter generating module 48 to generate a parameter with excellent dynamics and stability of concatenation between parameters.

First, the HMM parameter generating module 48 may derive a duration, spectral and f0 mean, and a variance parameter of a state from a speech model using label data as the text analysis result of the input text, and in this case, the spectral and the f0 parameter may include static, delta, and D-delta features. Then a spectrum parameter unit sequence and an excitation signal parameter unit sequence may be generated from the parameter sequence generator 300 using the label data. Then the HMM parameter generating module 48 may combine a speech model 110 and a parameter derived from the parameter sequence generator 300 to generate a last parameter using a MLE scheme. In this case, the mean value of static feature among the static, delta, D-delta, and variance parameters most largely affects the last parameter result, and thus it may be effective to apply the generated spectrum parameter unit sequence and the excitation signal parameter unit sequence to the static mean value.

In an embedded system with a limited resource, such as a mobile device or a CE device, in a process for establishing the speech parameter database 140 of the parameter sequence generator 300, only an excitation signal parameter except for a spectrum parameter may be stored and only a parameter unit sequence associated with the excitation signal parameter may be generated, and thus, although the parameter unit sequence is applied to the excitation signal parameter generating module 48-2 of the HMM-based speech synthesis unit 200, dynamics of excitation signal contour may be enhanced and synthesized speech with stable prosody may be generated. That is, the spectrum parameter generating module 48-1 may be an optional component.

Accordingly, the generated parameter unit sequence may be input to and combined with the HMM parameter generating module 48 to generate a last acoustic parameter, and the generated acoustic parameter may be lastly synthesized into an acoustic signal through a vocoder 20 (synthesis speech 49).

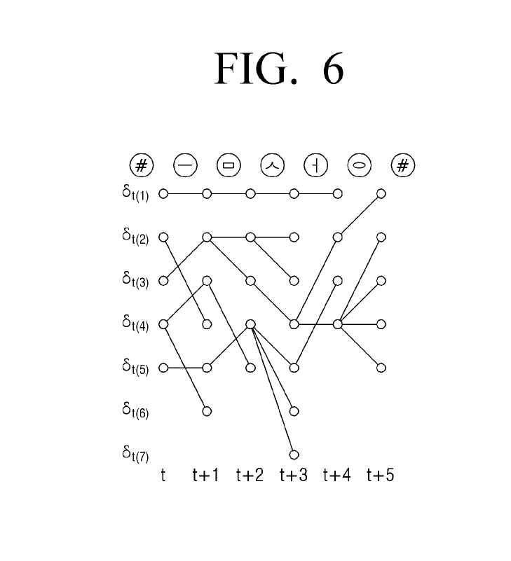

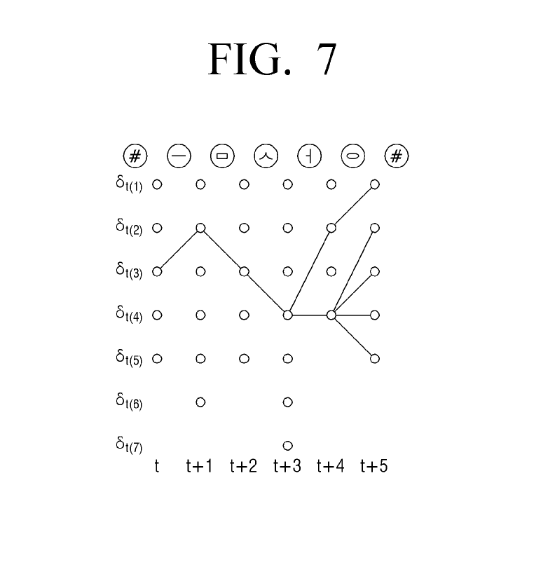

FIGS. 6 and 7 are diagrams for explanation of a method for generating a parameter unit sequence according to an exemplary embodiment of the present disclosure.

FIG. 6 illustrates a process for selecting various candidate unit parameters for speech synthesis of the word “ [symbol] ”. Referring to FIG. 6, when the word “ [symbol] ” is input, various modifications corresponding to ‘(#+−)’, ‘(−+▭)’, ‘(▭+ [symbol] )’, ‘( [symbol] + [symbol] )’, ‘( [symbol] + [symbol] )’, and ‘( [symbol] +#)’ may be derived from the speech parameter database 110 to search for an optimum concatenation path and speech waveforms may be concatenated to generate synthesized speech. For example, modification including a candidate unit parameter of ‘(▭+ [symbol] )’ may be ‘ [symbol] ’, ‘ [symbol] ’, or the like. In order to search for the optimum concatenation path, the target cost and the concatenation cost need to be defined, and viterbi search may be used as a searching method.

The input text as shown in FIG. 6 may be defined by consecutive di-phones as speech synthesis units according to an exemplary embodiment of the present disclosure, and an input sentence may be represented via concatenation of n di-phones. In this case, a plurality of candidate unit parameters may be selected for respective di-phones, and viterbi search may be performed in consideration of a cost function of target cost and concatenation cost. Accordingly, the selected candidate unit parameters may be sequentially combined and optimum candidate unit parameters of the respective candidate unit parameters may be retrieved.

As illustrated in FIG. 7, with regard to an entire text, when candidate unit parameters are not consecutively concatenated, a corresponding path may be removed and consecutively concatenated candidate unit parameters may be selected. In this case, a path with minimum cumulative cost with respect to the sum of target cost and concatenation cost may be an optimum concatenation path. Accordingly, the respective candidate unit parameters corresponding to the optimum concatenation paths may be combined to generate a parameter unit sequence corresponding to the input text.

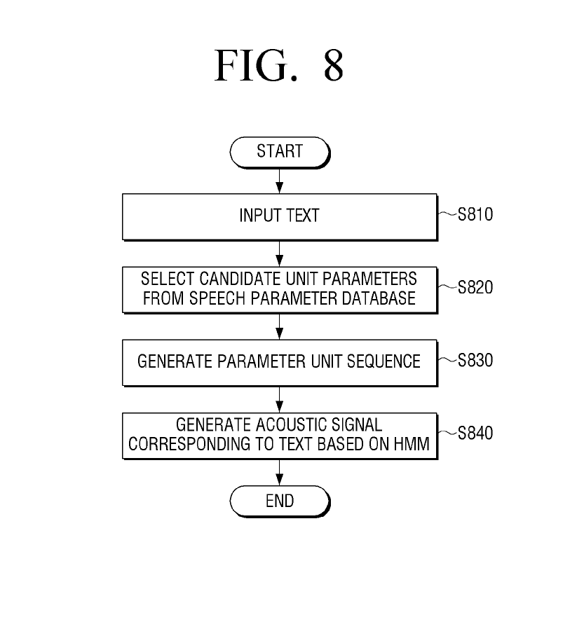

FIG. 8 is a flowchart for explanation of a speech synthesis method according to an exemplary embodiment of the present disclosure.

First, a text including a plurality of speech synthesis units may be received (input text) (S810). Then, candidate unit parameters that respectively correspond to a plurality of speech synthesis units constituting input texts may be selected from a speech parameter database that stores a plurality of parameters corresponding to speech synthesis units constituting a speech file (S820). Here, the speech synthesis unit may be any one of a phoneme, a semisyllable, a syllable, a di-phone, and a tri-phone. In this case, a plurality of candidate unit parameters corresponding to the respective speech synthesis units may be retrieved and selected, and an optimum candidate unit parameter may be selected among the plurality of selected candidate unit parameters. In this case, this process may be performed by calculating target cost and concatenation cost. In this case, the optimum concatenation path may be retrieved by calculating probability of concatenation between candidate unit parameters to search for a candidate unit parameter with highest concatenation probability. As a searching method, viterbi search may be used. Then, according to concatenation probability between candidate parameters, a parameter unit sequence for a partial or entire portion of a text may be generated (S830). Then, a synthesis part based on HMM may be performed using the parameter unit sequence to generate an acoustic signal corresponding to the text (S840). Here, the synthesis part based on HMM may apply a parameter unit sequence to the HMM speech parameter generated by a model trained by HMM to generate a synthesized speech signal compensated for prosody information. In this case, the model trained by HMM may refer to an excitation signal model or may further include a spectrum model.

According to the aforementioned various embodiments of the present disclosure, parameters of various prosodic modifications may be used to generate synthesized speech with enhanced naturalness compared with synthesized speech using a conventional HMM speech synthesis method.

A control method of a speech synthesis apparatus according to the aforementioned various embodiments of the present disclosure may be embodied as a program and may be stored in various recording media. That is, a computer program processed by various processors and for execution of the aforementioned various control methods of the speech synthesis apparatus may be stored in a recording medium and used.

For example, there may be provided a non-transitory computer readable medium for storing a program for performing receiving a text including a plurality of speech synthesis units, selecting candidate unit parameters that respectively correspond to a plurality of speech synthesis units constituting an input text, from a speech parameter database for storing a plurality of parameters corresponding to speech synthesis units constituting a speech file, generating a parameter unit sequence of a partial or entire portion of a text according to concatenation probability between consecutively concatenated candidate parameters, and performing a synthesis part based on hidden Markov model (HMM) using a parameter unit sequence to generate an acoustic signal corresponding to the text.

The non-transitory computer readable medium is a medium which does not store data temporarily such as a register, cash, and memory but stores data semi-permanently and is readable by devices. More specifically, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting embodiments of the present disclosure. The present teaching can be readily applied to other types of apparatuses and methods. Also, the description of exemplary embodiments of the present disclosure is intended to be illustrative, and not to limit the scope of the claims, and many alternatives, modifications, and variations will be apparent to those skilled in the art.

What is claimed is:

1. A speech synthesis apparatus comprising:
a speech parameter database configured to store a plurality of parameters respectively corresponding to speech synthesis units constituting a speech file;
an input unit configured to receive a text including a plurality of speech synthesis units; and
a processor configured to
select a plurality of candidate unit parameters respectively corresponding to the plurality of speech synthesis units included in the received text, from the plurality of parameters stored in the speech parameter database,
generate a parameter unit sequence of a partial or entire portion of the text according to probability of concatenation between consecutively concatenated candidate unit parameters of the selected plurality of candidate unit parameters, and
perform a synthesis operation based on a hidden Markov model (HMM) using the parameter unit sequence and thereby generate an acoustic signal corresponding to the text.

2. The speech synthesis apparatus as claimed in claim 1, wherein, to generate the parameter unit sequence of the partial or entire portion of the text, the processor:
sequentially combines candidate unit parameters of the selected plurality of candidate unit parameters,
searches for a concatenation path of the sequentially combined candidate unit parameters according to probability of concatenation between the candidate unit parameters, and
combines candidate unit parameters corresponding to the concatenation path.

3. The speech synthesis apparatus as claimed in claim 2, further comprising:
a storage configured to store an excitation signal model,
wherein, to generate the acoustic signal corresponding to the text, the processor:
applies the excitation signal model to the text to generate a HMM speech parameter corresponding to the text, and
applies the parameter unit sequence to the generated HMM speech parameter.

4. The speech synthesis apparatus as claimed in claim 3, wherein:
the storage further stores a spectrum model required to perform the synthesis operation; and,
to generate the HMM speech parameter corresponding to the text, the processor applies the excitation signal model and the spectrum model to the text.

5. A method comprising:
receiving a text including a plurality of speech synthesis units;
selecting a plurality of candidate unit parameters respectively corresponding to the plurality of speech synthesis units included in the received text, from a plurality of parameters corresponding to speech synthesis units constituting a speech file and that are stored in a speech parameter database;
generating a parameter unit sequence of a partial or entire portion of the text according to probability of concatenation between consecutively concatenated candidate unit parameters of the selected plurality of candidate unit parameters; and
performing a synthesis operation based on a hidden Markov model (HMM) using the parameter unit sequence and thereby generate an acoustic signal corresponding to the text.

6. The method as claimed in claim 5, wherein the generating the parameter unit sequence comprises:
sequentially combining candidate unit parameters of the selected plurality of candidate unit parameters;
searching for a concatenation path of the sequentially combined candidate unit parameters according to probability of concatenation between the candidate unit parameters; and
combining candidate unit parameters corresponding to the concatenation path to generate the parameter unit sequence of the partial or entire portion of the text.

7. The method as claimed in claim 5, wherein the performing the synthesis operation comprises:
applying an excitation signal model to the text to generate a HMM speech parameter corresponding to the text; and
applying the parameter unit sequence to the generated HMM speech parameter to generate the acoustic signal.

8. The method as claimed in claim 6, wherein the searching for the concatenation path uses a searching method via a viterbi algorithm.

9. The method as claimed in claim 7, wherein to generate the HMM speech parameter, the method further comprises:
applying a spectrum model required to perform the synthesis operation to the text to generate a HMM speech parameter corresponding to the text.

10. A non-transitory computer readable recording medium storing a program that, when executed by a hardware processor, causes the following to be performed:
receiving a text including a plurality of speech synthesis units;
selecting a plurality of candidate unit parameters respectively corresponding to the plurality of speech synthesis units included in the received text, from a plurality of parameters corresponding to speech synthesis units constituting a speech file and that are stored in a speech parameter database;
generating a parameter unit sequence of a partial or entire portion of the text according to probability of concatenation between consecutively concatenated candidate unit parameters of the selected plurality of candidate unit parameters; and
performing a synthesis operation based on a hidden Markov model (HMM) using the parameter unit sequence and thereby generate an acoustic signal corresponding to the text.
